(19) United States
(12) Patent Application Publication
(10) Pub. No.: US 2015/0314225 A1
(43) Pub. Date: Nov. 5, 2015

(54) FLUID FILTER HOUSING ASSEMBLY

(71) Applicant: Donaldson Company, Inc., Minneapolis, MN (US)

(72) Inventors: Jonathan G. Parsons, Lino Lakes, MN (US); Philip Johnson, Apple Valley, MN (US)

(21) Appl. No.: 14/701,671

(22) Filed: May 1, 2015

Related U.S. Application Data
(60) Provisional application No. 61/987,738, filed on May 2, 2014.

(51) Int. Cl. B01D 35/30

(52) U.S. Cl. CPC B01D 35/306

(57) ABSTRACT

A fluid filter housing assembly includes a filter housing that receives a filter cartridge and is secured in the housing with a hoop handle.

### RELATED APPLICATION

This application claims the benefit of U.S. Provisional Patent Application No. 61/987,738, filed on May 2, 2014, which provisional application is hereby incorporated herein by reference in its entirety to the extent that it does not conflict with the disclosure presented herein.

### FIELD

The disclosure relates to a fluid filter housing assembly and, in particular to a fluid filter housing that receives a filter cartridge that is secured in the housing with a hoop handle.

### BACKGROUND

Fluid streams often carry particulate material therein. In many instances, removal of some or all of the particulate material from a fluid flow stream is needed. For example, fluids may contain particulate material, for example, those generated by processes that included mining, milling, chemical processing, sintering, painting, energy production, etc. Before such fluids can be, or should be, directed through various downstream equipment and/or to the environment, a substantial removal of particulate material from those streams is important.

### BRIEF SUMMARY

The disclosure relates to a fluid filter housing assembly and, in particular to a fluid filter housing that receives a filter cartridge that is secured in the housing with a hoop handle. The housing can hold a plurality of oval filter cartridges that can be circumferentially pleated filtration media and each filter cartridge is held in place in the housing with individual hoop handles.

In many embodiments, a fluid filter housing assembly includes a filter housing and a filter cartridge. The filter housing includes a cartridge plate separating an inlet chamber from an outlet chamber. A fluid outlet is in fluid communication with the outlet chamber. A fluid inlet is in fluid communication with the inlet chamber. A hinged cover is in parallel relation to the cartridge plate when the hinged cover is in the closed position. The filter cartridge is disposed through the cartridge plate. The filter cartridge extends between an open end seated onto the cartridge plate and an opposing closed end. A hoop handle is fixed to the open end and contacts the hinged cover. The hinged cover deflects the hoop handle when the hinged cover is in the closed position.

In further embodiments, a fluid filter housing assembly includes a cylindrical filter housing and an oval filter cartridge. The cylindrical filter housing includes a cartridge plate separating an inlet chamber from an outlet chamber, a fluid outlet in fluid communication with the outlet chamber, a fluid inlet in fluid communication with the inlet chamber, and a hinged cover being in parallel relation to the cartridge plate in the closed position. The oval filter cartridge is disposed through the cartridge plate. The oval filter cartridge extends between an oval open end seated onto the cartridge plate and an opposing closed end. A hoop handle is fixed to the oval open end and contacting the hinged cover. The hinged cover deflects the hoop handle when the hinged cover is in the closed position.

The details of one or more embodiments of the disclosure are set forth in the accompanying drawings and the description below. Other features, objects, and advantages of the disclosure will be apparent from the description and drawings, and from the claims.

### BRIEF DESCRIPTION OF THE DRAWINGS

The disclosure may be more completely understood in consideration of the following detailed description of various embodiments of the disclosure in connection with the accompanying drawings, in which:

FIG. 1 is a schematic diagram of an illustrative fluid filter housing assembly;

FIG. 2 is a cross-sectional schematic diagram view of an illustrative inlet portion of the fluid filter housing assembly shown in FIG. 1;

FIG. 3 is a schematic diagram view of an illustrative pleated filter cartridge;

FIG. 4 is a perspective schematic diagram view of an illustrative cartridge plate receiving two filter cartridges each with a hoop handle;

FIG. 5 is a perspective schematic diagram view of an illustrative filter cartridge with hoop handle; and

FIG. 6 is a perspective cross-sectional view of the filter cartridge shown in FIG. 5.

The schematic drawings presented herein are not necessarily to scale. Like numbers used in the figures refer to like components, steps and the like. However, it will be understood that the use of a number to refer to a component in a given figure is not intended to limit the component in another figure labeled with the same number. In addition, the use of different numbers to refer to components is not intended to indicate that the different numbered components cannot be the same or similar.

### DETAILED DESCRIPTION

In the following detailed description, reference is made to the accompanying drawings that form a part hereof, and in which are shown by way of illustration several specific embodiments of devices and systems. It is to be understood that other embodiments are contemplated and may be made without departing from the scope or spirit of the present disclosure. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

As used in this specification and the appended claims, the singular forms “a”, “an”, and “the” encompass embodiments having plural referents, unless the content clearly dictates otherwise.

As used in this specification and the appended claims, the term “or” is generally employed in its sense including “and/or” unless the content clearly dictates otherwise.

As used herein, “have”, “having”, “include”, “including”, “comprise”, “comprising” or the like are used in their open ended sense, and generally mean “including, but not limited to.” It will be understood that the terms “consisting of” and “consisting essentially of” are subsumed in the term “comprising,” and the like.

Any direction referred to herein, such as “top,” “bottom,” “left,” “right,” “upper,” “lower,” “above,” below,” and other directions and orientations are described herein for clarity in reference to the figures and are not to be limiting of an actual device or system or use of the device or system. Many of the devices, articles or systems described herein may be used in a number of directions and orientations.

The disclosure relates to a fluid filter housing assembly and, in particular to a fluid filter housing that receives a filter cartridge that is secured in the housing with a hoop handle. The housing can hold a plurality of oval filter cartridges that can be circumferentially pleated filtration media. The oval filter cartridge can have an obround shape where the hoop handle is fixed to the semicircle ends of the obround shape. The hoop handle can be the primary holding force to maintain the filter cartridge in the cartridge plate of the filter housing. In many embodiments the filter cartridge is not fastened to the cartridge plate, for example with bolts or screws or clips even when the filter is oriented horizontally. Thus, the filter cartridge can be replaced without the need for tools to remove the filter cartridge from the cartridge plate. In addition the housing can contain a plurality or two or more filter cartridges each having a separate hoop handle fixed to them. Each filter cartridge is secured in the housing with its hoop handle and each hoop handle being the primary holding force to maintain each filter cartridge in the cartridge plate of the filter housing. While the present disclosure is not so limited, an appreciation of various aspects of the disclosure will be gained through a discussion of the examples provided below.

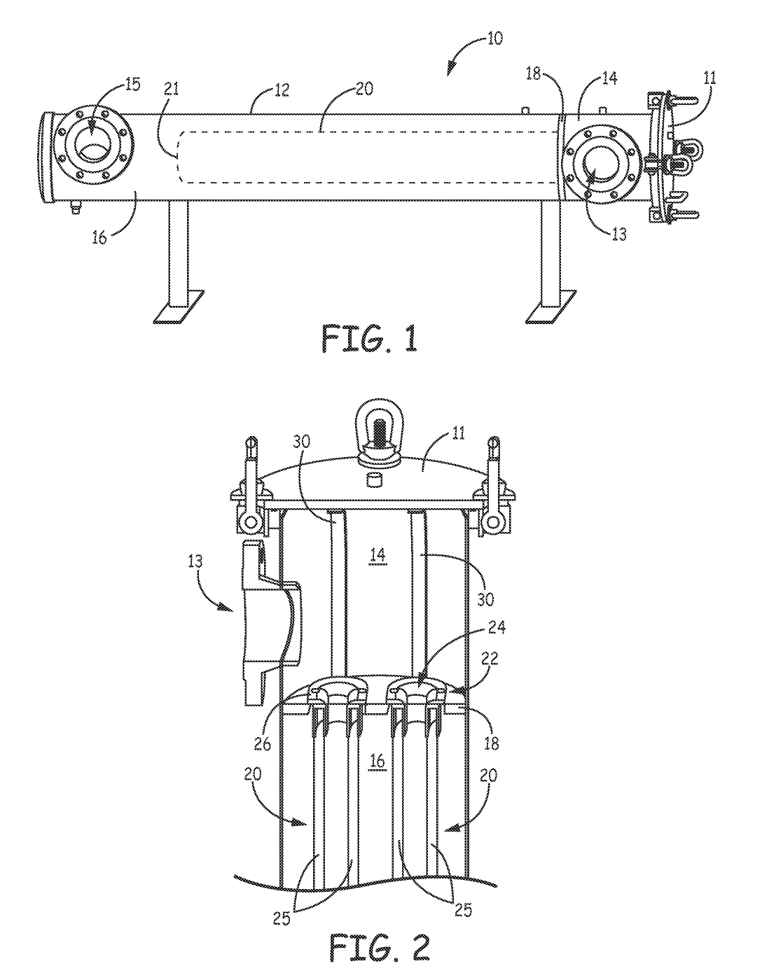

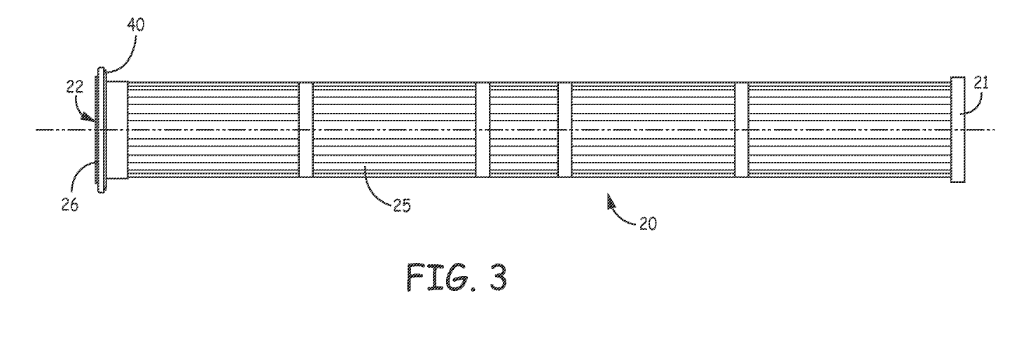

FIG. 1 is a schematic diagram of an illustrative fluid filter housing assembly 10. FIG. 2 is a cross-sectional schematic diagram view of an illustrative inlet portion of the fluid filter housing 10 assembly shown in FIG. 1. FIG. 3 is a schematic diagram view of an illustrative pleated filter cartridge 20.

In many embodiments the fluid filter housing assembly 10 includes a filter housing 12 and a filter cartridge 20. The filter housing 12 includes a cartridge plate 18 separating an inlet chamber 14 from an outlet chamber 16. A fluid outlet 15 is in fluid communication with the outlet chamber 16. A fluid inlet 13 is in fluid communication with the inlet chamber 14. A hinged cover 11 is in parallel relation to the cartridge plate 18 when the hinged cover 11 is in the closed position. The filter cartridge 20 is disposed through the cartridge plate 18. The filter cartridge 20 extends between an open end 22 seated onto the cartridge plate 18 and an opposing closed end 21. A hoop handle 30 is fixed to the open end 22 and contacts the hinged cover 11. The hinged cover 11 deflects the hoop handle 30 when the hinged cover 11 is in the closed position.

The fluid filter housing assembly 10 can include a filter housing 12 and a plurality of filter cartridges 20 disposed through the cartridge plate 18, each filter cartridge 20 includes a hoop handle 30 fixed to the open end 22 and contacting the hinged cover 11. In one embodiment, the fluid filter housing assembly 10 has a filter housing 12 and two filter cartridges 20 disposed through the cartridge plate 18, each filter cartridge 20 includes a hoop handle 30 fixed to the open end 22 and contacting the hinged cover 11, thus two hoop handles 30 contact the hinged cover 11.

In further embodiments, a fluid filter housing assembly 10 includes a cylindrical filter housing 12 and an oval filter cartridge 20. The cylindrical filter housing 12 includes a cartridge plate 18 separating an inlet chamber 14 from an outlet chamber 16, a fluid outlet 15 in fluid communication with the outlet chamber 16, a fluid inlet 13 in fluid communication with the inlet chamber 14, and a hinged cover 11 in parallel relation to the cartridge plate 18 in the closed position. The oval filter cartridge 20 is disposed through the cartridge plate 18. The oval filter cartridge 20 extends between an oval open end 22 seated onto the cartridge plate 18 and an opposing closed end 21. A hoop handle 30 is fixed to the oval open end 22 and contacting the hinged cover 11. The hinged cover 11 deflects the hoop handle 30 when the hinged cover 11 is in the closed position.

Fluid piping is not illustrated but readily appreciated by those with skill in the art. Fluid enters the inlet chamber 14 through the fluid inlet 13. This fluid then enters the inlet 24 of the filter cartridge 20 and passes through the filtration media 25. Particulate material remains within the filter cartridge 20 and filtered fluid enters the outlet chamber 16 passes out of the fluid filter housing assembly 10 via the fluid outlet 15.

The filter cartridge 20 can optionally include an inner support structure or inner core (not shown) extending between the open end 22 and the opposing closed end 21. The filter housing 12 can optionally include an outer support structure (not shown) disposed about the filter cartridge 20.

The filter cartridge 20 can have any useful cross-sectional shape. Preferably the filter cartridge 20 can have an oval cross-sectional shape as illustrated in the figures. Oval shaped filter cartridges 20 have been found to provide an increased filtration surface area as compared to round or cylindrical shaped filter cartridges. In particular, circumferentially pleated oval filter cartridge 20 have been found to provide an increased filtration surface by at least five times as compared to round or cylindrical shaped filter cartridges. Utilizing the pleated oval filter cartridge 20 has been found to decrease pressure drop, increase flow rate or capacity through the filter cartridge 20, as compared to standard round filter cartridges. For example, a standard 10 inch housing with a round 6 inch filter cartridge is rated for 100 to 200 gpm (gallons per minute) of flow rate. In contrast, two oval pleated filter cartridges can be received in the same standard 10 inch housing and operate to filter 300 to 500 gpm.

In many embodiments the oval filter cartridge 20 has an obround shape. The obround filter cartridge 20 shape is a closed figure having two parallel sides and two semicircular ends. The hoop handle 30 is preferably fixed to semicircle ends of the obround filter cartridge 20. In many embodiments the hoop handle 30 is fixed to the midpoint of each semicircle end of the obround filter cartridge 20. The hinged cover 11 deflects the hoop handle 30 when the hinged cover 11 is in the closed position.

In many embodiments the oval filter cartridge 20 has a hoop handle 30 that defines a hoop handle opening. The fluid inlet 13 is aligned with the hoop handle opening. This allows fluid to flow from the fluid inlet 13 to the first open end 22 of the filter cartridge 20 with minimum flow disruption from the hoop handle 30.

The filter cartridge 20 includes a length of filtration media 25 that can be circumferentially pleated. The length of filtration media 25 extends between a first open end 22 and an opposing closed end 21. An end cap 26 can be formed of an elastomer material and define a fluid inlet 24 and can be molded to the first open end 22. The closed end 21 can include a metal or rigid pan sealed to the filtration media with a useful adhesive, for example.

The end cap 26 can directly bond to the filtration media 25. The end cap 26 can mechanically maintain the circumferentially pleated first open end 22. In many embodiments the end cap 26 can be injection molded to the first open end 22 of the filter cartridge 20. The filtration media 25 can be formed of any useful filtration material.

The filter cartridge 20 can includes a gasket 40 separating an inlet surface of the cartridge plate 18 from the filter cartridge end cap 26. The gasket 40 can be disposed between the end cap 26 and the tube sheet 18 to aid in sealing the upper chamber 14 from the lower chamber 16. In some embodiments the end cap 26 includes a rigid collar. The rigid collar can be any useful material such as metal.

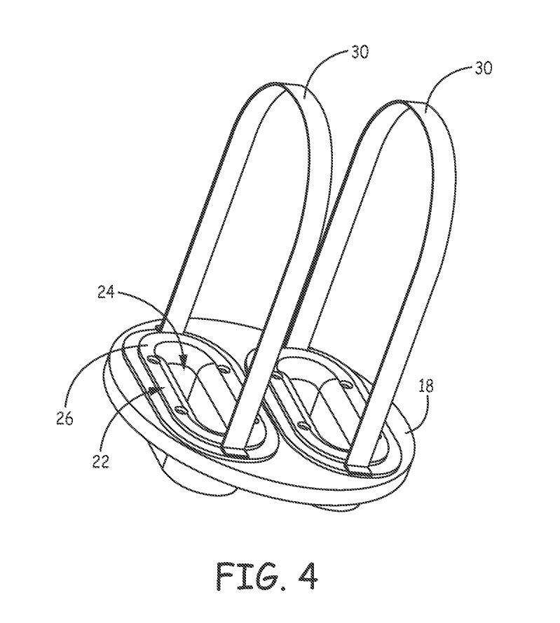

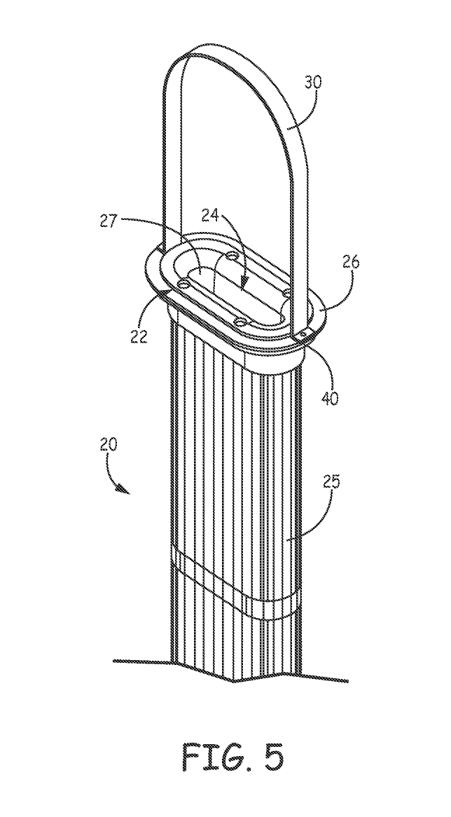

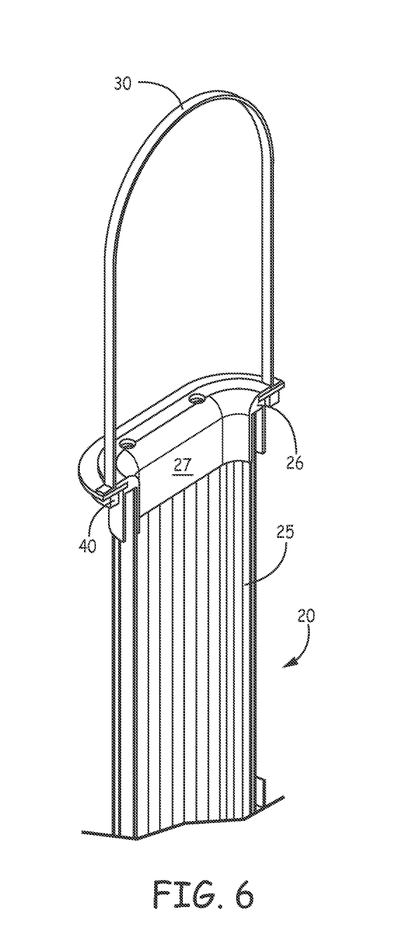

FIG. 4 is a perspective schematic diagram view of an illustrative cartridge plate 18 receiving a two filter cartridges 20 each with a hoop handle 30. FIG. 5 is a perspective schematic diagram view of an illustrative filter cartridge 20 with hoop handle 30. FIG. 6 is a perspective cross-sectional view of the filter cartridge 20 shown in FIG. 5.

The end cap 26 can optionally include a plenum 27 that extends into the inlet 24 of the filter cartridge 20. The end cap 26 can be unitary element or include a rigid collar. The hoop handle 30 can be fixed to the end cap 26 or rigid collar of the end cap 26. In embodiments where the end cap 26 defines an oval cross-sectional shape, the hoop handle 30 can be fixed to opposing narrow end sides of the end cap 26. The hoop handle 30 defines a strip of material that has two opposing ends that are fixed to the end cap 26 and form a loop extending away from the end cap 26.

The hoop handle 30 can be formed of any useful resilient material, for example a metallic material. The hoop handle 30 can have two linear extending legs fixed together by an curved portion. In many embodiments, the hoop handle 30 can have two parallel extending legs fixed together by an semi-circle portion. At the end of each linear extending leg is a lip element that can extend orthogonally to the linear extending leg. The lip element can be fixed to the end cap 26 or rigid collar of the filter cartridge 20 as illustrated in FIG. 4, FIG. 5 and FIG. 6.

In many embodiments the hoop handle can deflect when a force is applied to the loop portion of the hoop handle 30. For example the parallel extending legs of the hoop handle 30 can deflect away from each other and/or the loop portion of the hoop handle 30 can defect toward the end cap 26 of the filter cartridge 20. In many embodiments the hoop handle 30 deflects at least about 5 mm or at least about 10 mm or at least about 20 mm or at least about 30 mm or in a range from 1 to 30 mm. In particular the hoop handle 30 deflects in these ranges when the hinged cover 11 is closed against the hoop handle 30.

Surprisingly the hoop handle 30 has been found to secure the open end 22 or end cap 26 of the filter cartridge 20 against the cartridge plate 18 primarily by the force applied to the hoop handle 30 by the hinged cover 11. Even when the filter housing 10 and filter cartridge 20 is oriented in a horizontal direction, the open end 22 or end cap 26 of the filter cartridge 20 against the cartridge plate 18 primarily by the force applied to the hoop handle 30 by the hinged cover 11. Thus a fastener is not needed to secure the filter cartridge 20 against the cartridge plate 18.

The filter cartridge 20 can be replaced by opening the hinged cover 11 and grasping the hoop handle and pulling the used filter cartridge 20 out of the housing 12 without use of any other tools. Then a clean filter cartridge 20 can be inserted into the housing 12 and secured into the housing 12 simply by closing the hinged cover 11. The hinged cover 11 deflects the hoop handle 30 and applies a spring force to the end cap 26 of the filter cartridge 20 against the cartridge plate 18 and thus sealing the filter cartridge 20 into the housing 12. Tools are not needed to seal the filter cartridge 20 into the housing 12.

The hoop handle 30 can extend a distance beyond the inlet chamber 14 height when the filter cartridge 20 is initially placed into the filter housing 12. Then the cover 11 (that can be pivotally attached to the housing 12) can be moved into a closed position sealing the inlet chamber 14. Thus the cover 11 contacts the hoop handle 30 just before the cover 11 moves into the closed position. In many embodiments the hoop handle 30 extends out of the inlet chamber 14 at least about 5 mm or at least about 10 mm or at least about 20 mm or at least about 30 mm or in a range from 1 to 30 mm. Thus, the hoop handle 30 deflects at least about 5 mm or at least about 10 mm or at least about 20 mm or at least about 30 mm or in a range from 1 to 30 mm by the cover 11 moving into the closed position.

Thus, embodiments of FLUID FILTER HOUSING ASSEMBLY are disclosed. One skilled in the art will appreciate that the optical films and film articles described herein can be practiced with embodiments other than those disclosed. The disclosed embodiments are presented for purposes of illustration and not limitation.

What is claimed is:

1. A fluid filter housing assembly comprising:
a filter housing comprising:
a cartridge plate separating an inlet chamber from an outlet chamber;
a fluid outlet in fluid communication with the outlet chamber;
a fluid inlet in fluid communication with the inlet chamber;
a hinged cover being in parallel relation to the cartridge plate in the closed position;
a filter cartridge disposed through the cartridge plate, the filter cartridge extending between an open end seated onto the cartridge plate and an opposing closed end the filter cartridge comprises circumferentially pleated filtration media; and
a hoop handle fixed to the open end and contacting the hinged cover, the hinged cover deflects the hoop handle when the hinged cover is in the closed position.

2. The fluid filter housing assembly according to claim 1, wherein the open end is held in place against the cartridge plate primarily by the force applied to the hoop handle by the hinged cover.

3. The fluid filter housing assembly according to claim 1, wherein the open end is not fastened to the cartridge plate.

4. The fluid filter housing assembly according to claim 1, wherein the hoop handle deflects in a range from 1 to 30 mm when the hinged cover is closed against the hoop handle.

5. The fluid filter housing assembly according to claim 1, further comprising a plurality of filter cartridges disposed through the cartridge plate, each filter cartridge includes a hoop handle fixed to the open end and contacting the hinged cover.

6. The fluid filter housing assembly according to claim 1, wherein the filter cartridge open end defines an oval shaped opening.

7. The fluid filter housing assembly according to claim 1, wherein the hoop handle is metallic.

8. The fluid filter housing assembly according to claim 1, wherein the filter housing further comprises an outer support structure disposed about the filter cartridge.

9. The fluid filter housing assembly according to claim 1, wherein the cartridge plate outer circumference defines a circular shape.

10. The fluid filter housing assembly according to claim 1, wherein the filter cartridge comprises an inner support structure or inner core extending between the open end and the opposing closed end.

11. The fluid filter housing assembly according to claim 1, further comprising a gasket separating an inlet surface of the cartridge plate from the open end of the filter cartridge.

12. A fluid filter housing assembly comprising:
a cylindrical filter housing comprising:
a cartridge plate separating an inlet chamber from an outlet chamber;
a fluid outlet in fluid communication with the outlet chamber;
a fluid inlet in fluid communication with the inlet chamber;
a hinged cover being in parallel relation to the cartridge plate in the closed position;
an oval filter cartridge disposed through the cartridge plate, the oval filter cartridge extending between an oval open end seated onto the cartridge plate and an opposing closed end, the oval filter cartridge comprises circumferentially pleated filtration media; and
a hoop handle fixed to the oval open end and contacting the hinged cover, the hinged cover deflects the hoop handle when the hinged cover is in the closed position.

13. The fluid filter housing assembly according to claim 12, further comprising a plurality of oval filter cartridges disposed through the cartridge plate, each oval filter cartridge includes a hoop handle fixed to the open end and contacting the hinged cover.

14. The fluid filter housing assembly according to claim 12, wherein the oval open end is held in place against the cartridge plate primarily by the force applied to the hoop handle by the hinged cover.

15. The fluid filter housing assembly according to claim 12, wherein the oval open end is not fastened to the cartridge plate.

16. The fluid filter housing assembly according to claim 12, wherein the hoop handle deflects in a range from 1 to 30 mm when the hinged cover is closed against the hoop handle.

17. The fluid filter housing assembly according to claim 12, wherein the hoop handle defines a hoop handle opening and the fluid inlet is aligned with the hoop handle opening allowing fluid to flow from the fluid inlet to the first open end of the filter cartridge with minimum flow disruption from the hoop handle.

18. The fluid filter housing assembly according to claim 12, wherein the filter cartridge comprises an oval inner support structure extending between the oval open end and the opposing closed end and the housing comprises an oval outer support structure disposed about the oval filter cartridge.

19. The fluid filter housing assembly according to claim 12, further comprising a gasket separating an inlet surface of the cartridge plate from the oval open end of the filter cartridge.
